(19) United States
(12) Patent Application Publication
(10) Pub. No.: US 2005/0242644 A1
(43) Pub. Date: Nov. 3, 2005

(54) Method for filling at least two receptacles and pneumatic circuit for carrying out said method

(76) Inventors: Bertram Bauer, Gaggenau (DE); Harald Merz, Sinzheim (DE); Daniel Konrad, Ann Arbor, MI (US); Wolfgang Paessler, Achern (DE)

Correspondence Address: MICHAEL BEST & FRIEDRICH, LLP, 100 E WISCONSIN AVENUE, MILWAUKEE, WI, 53202, US

(21) Appl. No.: 10/525,308

(22) PCT Filed: Jul. 25, 2003
(86) PCT No.: PCT/DE03/02508

§ 371 Date: Feb. 22, 2005

(30) Foreign Application Priority Data
Aug. 21, 2002 (DE) 10238240.9

(51) Int. Cl. H01S 4/00; A61H 7/00

(52) U.S. Cl. 297/284.3; 297/284.4; 601/148

(57) ABSTRACT

The invention relates to a method to act upon at least two recipients (10, 11, 12) of a pneumatic system in an alternating manner, in particular a pneumatic massage system of a motor vehicle seat, with a pressure medium flow. It is proposed in accordance with the invention that at least one, first air cushion (10, 11, 12) that serves as a recipient (10, 11, 12) be filled with a gaseous working fluid, while the working fluid is actively suctioned off from at least one other, second air cushion (10, 11, 12). The corresponding pneumatic circuit is connected in such a way that the at least one, first recipient (10, 11, 12) is connected to the at least one, second recipient (10, 11, 12) via connecting means (14, 16, 18, 20, 88, 90, 94, 96, 98) and a feed pump (22). In addition, a vehicle seat is proposed, in particular a seat for a motor vehicle, in which at least two recipients (10, 11, 12) are integrated, which recipients are acted upon via the method in accordance with the invention in an alternating manner with a pressure medium flow of the working fluid.

The invention is relates to a method to act upon at least two recipients of a pneumatic system in an alternating manner, for example a massage system of a motor vehicle seat, with a pressure medium flow. In addition, the invention relates to a pneumatic circuit to execute this method.

### PRIOR ART

Pneumatic control and regulation circuits are used in numerous technical applications. Thus, pneumatic methods and corresponding pneumatic circuits are used in the motor vehicle industry, for example, to adjust the otherwise standardized contour of vehicle seats to external influences or to the individual desires of the user of the motor vehicle.

A pneumatically controlled seat for a vehicle is known from U.S. Pat. No. 4,655,505, which makes it possible for the driver to vary the pressure distribution of the seat. This device includes a plurality of flexible air chambers integrated into the vehicle seat, which are connected to an air pump and a pressure sensor via a corresponding number of connecting means. Each connecting means has a valve, which can be triggered via electronic control means, which evaluate the signal from the pressure sensor.

The combined, pneumatic and electric circuit of this device permits defined pressures to be built up in the individual air chambers of the seat due to the plurality of the valves and, therefore, to increase both the comfort of the seat as well as to take the longitudinal or lateral accelerations of the vehicle into account.

In particular, the device in U.S. Pat. No. 4,655,505 permits the pressure in each individual air chamber to be varied continuously in terms of time so that an optimized pressure distribution can be adjusted or the driver experiences a massage effect due to an oscillating change in the pressure conditions in the air chambers.

An expensive electrical control and regulating unit with corresponding electronics and at least one pressure sensor as well as a central computing unit is necessary to achieve this variation in the pressure conditions of the individual air chambers of the seat in U.S. Pat. No. 4,655,505.

The objective of the present invention is realizing a method or a pneumatic circuit to act upon at least two recipients of a pneumatic system in an alternating manner with a pressure medium flow, which method makes adequate filling of the involved recipients possible in a simple, but reliable manner.

The objective is attained with the method in accordance with the invention or by the pneumatic circuit in accordance with the invention with the features of claim 1 or claim 10.

### ADVANTAGES OF THE INVENTION

The method in accordance with the invention to act upon at least two recipients of a pneumatic system in an alternating manner, in particular a pneumatic massage system of a motor vehicle seat, with a pressure medium flow or the corresponding pneumatic circuit provides that at least one, first air cushion that serves as a recipient is filled with a gaseous working fluid, while the working fluid is actively suctioned off from at least one other, second air cushion. The method in accordance with the invention or the pneumatic circuit to execute this method improves the operation, e.g., of an air-chamber-driven massage system in a vehicle seat by replacing the passive deaeration of the cushions according to the prior art with an active deaeration. A passive deaeration is very much a function of the environmental conditions (e.g., seat design, driver weight, ambient temperature, etc.). With an active evacuation of the concerned cushions, the achievable massage effect is more greatly noticeable. In a seat massage system, which is composed of at least two air cushions that are installed in a vehicle seat, on an alternating basis one cushion is filled with air or another kind of gaseous working fluid and the air is actively suctioned off in the other cushion. Because of this suctioning off of the air, the corresponding cushion is emptied better, thereby intensifying the massage effect that is a function of the pressure difference in the concerned air cushions.

Advantageous improvements and further developments of the method disclosed in claim 1 or the pneumatic circuit described in claim 10 are possible as a result of the measures and features listed in the other claims.

The pressure in the at least one, to be-emptied air cushion can be used to advantageously fill the at least one, to-be-filled air cushion. In this case, the designation “air cushion” is not limited to the use of air as a working fluid in the pneumatic system. The term “cushion” should also be understood in a wider sense and should include at least an inflatable recipient. Such a pneumatic system can be realized with an entire series of gaseous working fluids. By actively emptying the one air cushion, the pressure in the to-be-emptied cushion can be used to fill another cushion, instead of escaping into the atmosphere as is the case with the corresponding systems of the prior art. This essentially closed operating cycle means an improvement in the efficiency of the pneumatic system as well as an energy savings when operating such a system.

In an advantageous embodiment of the method in accordance with the invention, the alternating filling of the air cushions is achieved by a reversal of the rotational direction of the pump conveying the working fluid. Using such a pump permits the concerned air cushions to be filled or emptied in an alternating manner in a very simple way. Such a pump is driven in an advantageous manner by an electric motor, whose speed and rotational direction is presettable, e.g., via a corresponding control unit.

A pneumatic system can be realized in this way, in which the final pressure in the to-be-filled recipient (air cushion) or the frequency of the working fluid acting upon the concerned recipients in an alternating manner is presettable.

Thus, for example the final pressure in the to-be-filled cushion, which determines the hardness of the vehicle seat and specifies the intensity of the massage effect, can be preset manually via corresponding operating elements. In this way, it is possible to take different users or different usage conditions of the vehicle seat into account. In addition to the desired final pressure in the air cushions, the frequency with which the air cushions are filled and emptied, for example, can also be manually adjusted and thereby adapted to the individual driving situation.

In an alternative exemplary embodiment of the method in accordance with the invention, the filling of the recipients is controlled by a control unit, which obtains information about the occupation of the seat via various detectors. Thus, for example the weight of the vehicle user, the body size or even the elapsed travel time can be detected via corresponding sensors and transmitted to the control unit. Control programs to activate the air cushions that have been adapted to the driver type and the driving situation can be selected in the control unit via correspondingly stored characteristic curves. Thus, it is possible for example to take a very long travel time into account by a slight massage effect counteracting the driver's fatigue. It is also conceivable to detect the so-called microsleep of a driver and to alert the driver to this situation by an intensified massage effect and to prevent further “nodding off.”

In one embodiment of the method in accordance with the invention, the final pressure in the at least one, to-be-filled recipient and/or the frequency of the working fluid acting upon the at least two recipients in an alternating manner is controlled or regulated by a constriction of the pressure medium flow on the pressure side of the feed pump, in particular by a throttling valve.

In an alternative embodiment the final pressure or the frequency of the action is controlled or regulated by actuating a bypass between the suction side and the pressure side of the feed pump for the working fluid.

The pneumatic circuit to act upon at least two recipients of a pneumatic system in an alternating manner with a pressure medium flow advantageously features a feed pump and connecting means, which are connected with one another in such a way that the at least one, first recipient is connected to the at least one, second recipient via the connecting means and the feed pump. An essentially closed conveyance system in which the working medium is merely transferred by pumping over is yielded in this way. In addition, the pneumatic circuit can feature a recipient that serves as a storage reservoir for the working fluid.

The suction side of the feed pump for example can be connected to at least one, first recipient, while the pressure side of the feed pump is simultaneously connected to at least one, second recipient. The reversal of the rotational direction of the feed pump permits simple pumping over of the working fluid to be realized in this way.

In another exemplary embodiment of the pneumatic circuit in accordance with the invention, a component controlling the pressure medium flow can be connected on the suction side of the feed pump with at least one recipient. A corresponding design of the controlling component makes it possible for the pressure side of the feed pump to also be connected to the same component.

Such a pressure control means can advantageously be realized as a pneumatically driven actuator, which regulates the acting upon of the recipients in an alternating manner. In this case, it is possible to use a simple feed pump without the possibility of the reversal of rotational direction.

A component with a valve that can be regulated and switched can be used as the pressure control means in a simple and therefore advantageous manner.

The feed pump can be embodied advantageously as a vane-cell pump, in particular as a vane-cell pump with means to reverse the rotational direction. In another advantageous exemplary embodiment of the pneumatic circuit, the connecting means between the feed pump and the recipients features an output valve, which opens the connecting line when a specific pressure limit is reached on the suction side of the pump in order to supply additional working fluid to the system.

Such a pneumatic system can be installed in an advantageous manner in a vehicle seat, in particular the seat of a motor vehicle, so that a massage effect can be realized in the vehicle seat with the aid of the method in accordance with the invention, which expands vehicle comfort as well as increases travel safety.

With the method in accordance with the invention or the pneumatic circuit in accordance with the invention to execute this method it is possible to improve the functioning of a massage system, in particular a massage system for a vehicle seat, by replacing the passive deaeration of the recipients with an active deaeration. As a result, it is possible to realize a massage system that is largely independent of the environmental conditions.

### DRAWINGS

Exemplary embodiments of the pneumatic circuit in accordance with the invention are depicted in the drawing and are supposed to be explained in greater detail in the following description. The figures of the drawing, the description thereof as well as the claims contain numerous features in combination. A person skilled in the art will also observe these features individually and combine them into additional, meaningful combinations.

The drawing shows:

FIG. 1A first exemplary embodiment of a pneumatic circuit to execute the method in accordance with the invention.

FIG. 2A second exemplary embodiment of a pneumatic circuit in accordance with the invention.

FIG. 3 Another exemplary embodiment of a pneumatic circuit in accordance with the invention.

FIG. 4 Another exemplary embodiment of a pneumatic circuit in accordance with the invention with an enlarged number of recipients.

### DESCRIPTION OF THE EXEMPLARY EMBODIMENTS

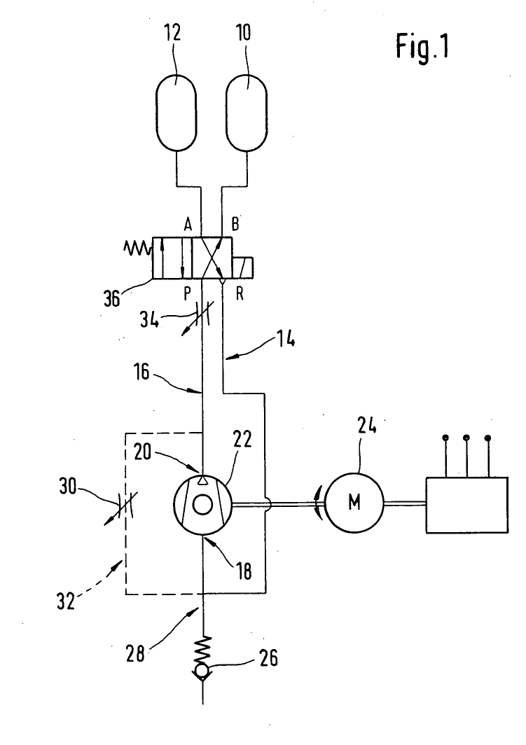

FIG. 1 shows a first exemplary embodiment of a pneumatic circuit like those that can be integrated into a vehicle seat to achieve a massage effect. Such a system is comprised of at least two recipients 10 or 12, which can be embodied in the form of inflatable air cushions for example. The two recipients 10 or 12 are connected to connecting means in the form of hoses 14 or 16 with the suction side 18 or the pressure side 20 of a feed pump 22. The pump 22 is driven by an electric motor 24, which is regulated via a control unit (not depicted here in further detail). Located on the suction side of the pump 22 is also an output 26, which is closed under normal operating conditions. When a specific pressure limit is reached on the suction side of the feed pump 22, this output valve is opened and additional air is supplied to the system via the connecting line 28.

An adjustable valve 30, which can be arranged in a bypass 32 between the suction side 18 and the pressure side 20 of the feed pump 22, can regulate the pumping capacity of the pump 22. To do so, the adjustable valve 30 can possess a control for example, which is connected with the central control unit of the pneumatic circuit, which also regulates the electric motor 24 of the feed pump 22.

Alternatively or in addition, a control valve 34 can be arranged on the pressure side of the feed pump. Because of the corresponding regulation, the pressure in the cushions and the frequency of the working fluid acting upon the cushions can be influenced.

In the present exemplary embodiment in FIG. 1, the alternating acting upon of the air cushions with a pressure medium flow is realized by an actuator 36, which makes it possible, independent of the actuator setting, to connect the pressure side 20 of the feed pump 22 either to the recipient 12 or alternatively to the recipient 10. The remaining second recipient is then correspondingly connected to the suction side 18 of the feed pump 22. As already described, FIG. 1 shows an actuator 36 setting, which connects the recipient 10 to the pressure side 20 and the recipient 12 to the suction side 18 of the feed pump 22. As a result, in the exemplary embodiment in FIG. 1, when the feed pump 22 is turned on, the recipient 10 is acted upon with the pressure medium flow of the working fluid, while at the same time the working fluid from the recipient 12 is actively pumped over via the feed pump 22.

Pressure sensors, which can monitor the pressure in the to-be-filled recipients, are located in the recipients, the connecting lines or even in the feed pump. The control unit can also prescribe a specific feed time for the feed pump 22 for example, which, with a known pumping capacity of this pump, determines the final pressure in the to-be-filled recipient. In addition, this final pressure can also be adjusted via the control valves 30 or 34, for example. If the actuator 36 changes its position, then the filled recipient 10 is now connected to the suction side of the feed pump 22 so that this recipient is now actively emptied and the working fluid is pumped over into the now to-be-filled recipient 12 via the feed pump 22.

By prescribing the change frequency for the actuator 36 setting, the frequency of the working fluid acting upon the two recipients in an alternating manner can thus be preset for example. The actuator 36 can be operated mechanically, for example, or else even pneumatically.

The pneumatic system depicted in FIG. 1 can be integrated in advantageously into the vehicle seat of a motor vehicle, whereby this system is not limited to the use of only two recipients. On the contrary, the principle sequence of the method in accordance with the invention and the fundamental structure of the associated pneumatic circuit in accordance with the invention are supposed to be explained with the exemplary embodiment in FIG. 1. A real pneumatic system, e.g., to generate a massage effect in a vehicle seat may have a plurality of air cushions to be acted upon. In addition, the feed pump or the motor driving the pump does not have to be attached in the direct vicinity of the recipients, but, to avoid the excessive development of noise, it can be accommodated via correspondingly connecting means at some distance from the recipients and thus from the vehicle passengers.

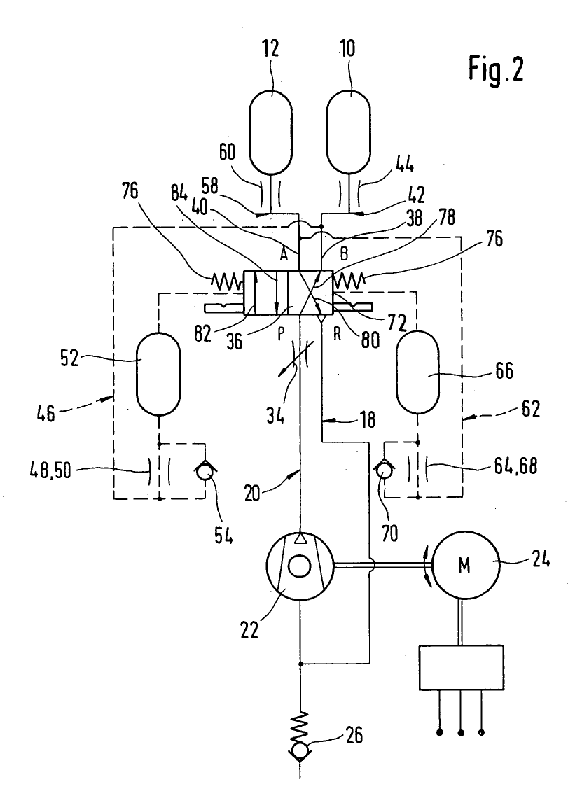

FIG. 2 shows an exemplary embodiment of a pneumatic circuit in accordance with the invention, in which the actuator 36 is a pneumatic actuator. The pneumatic circuit depicted in FIG. 2 shows an actuator 36, which connects the pressure side 20 of the feed pump 22 to a first output channel 38 and at the same time a second output channel 40 to the suction side 18 of the feed pump 22. A control valve 34 is connected in series to the actuator 36 on the pressure side of the feed pump 20. The output channel 38 of the actuator 36 is connected to the recipient 10 via connecting means 42. The connecting means 42 features a constrictor 44 among other things, which can be used to adjust the flow through the connecting means 42 in a desired manner. Branching off from the connecting means 42 between the actuator 36 and the recipient 10 is another connecting means 46, which is leads to a reservoir 52 via a time-lag element 48, which is realized by a constrictor 50 in the present exemplary embodiment. The reservoir can be emptied via a reflux valve 54 and the connecting means 46. The reservoir 52 is in turn coupled with the actuator 36 via a device 56 using pressure technology.

One the one hand, the second output channel 40 of the actuator 36 is coupled via connecting means 58 and a constrictor 60 to the second recipient 12 and, on the other hand, via connecting means 62 and a constrictor 64 to a second reservoir 66. The supply line to the reservoir 66 also features a time-lag element 68 and a reflux valve 70 for deaerating the reservoir. Like the reservoir 52, the reservoir 66 is connected to the actuator 36 via a device 72, but on the opposite side.

In its interior, the actuator 36 features continuous channels, which produce the connection between the pressure side 20 with one of the connecting means 42 or 58 as well as a connection of the suction side 18 of the feed pump 22 with the respective connecting means 42 or 58 not connected with the pressure side. The mobility of the actuator 36 is regulated by a counter device 76, which is depicted schematically as an elastic spring in FIG. 2.

The functioning of the pneumatic circuit in accordance with the invention shall be described in more detail in the following in accordance with the exemplary embodiment in FIG. 2. If the pressure side 20 of the circuit in accordance with the invention is acted upon with a working fluid such as air, then the pressure medium reaches the recipient 10, which can be formed e.g., as an elastic air cushion, via a channel 78 and the constrictor 44. The air cushion 10 will fill with the pressure medium and be inflated accordingly. At this point in time, recipient 12 is connected with the suction side of the feed pump 22 via a channel 80 so that the working fluid present in the recipient 12 is supplied to recipient 10 via the connecting lines and the feed pump 22. While the air cushion 10 is inflated, a portion of the pressure medium flow is supplied to the recipient 52, which is being used as the working chamber, via the connecting means 46 and the correspondingly adjusted constrictor 48. The precise adjustment of the constrictor 50 thereby determines the time that is necessary to fill the working chamber 52. The working chamber 52 is connected e.g., via an elastic membrane or another device 56 to the actuator 36. If the pressure in the working chamber 52 increases, and the membrane or the corresponding device 56 expands, a force is exerted on the actuator 36. The actuator 36 is locked via a counter device 76, which is indicated in the form of two elastic springs in FIG. 2. If the force being exerted on the actuator 36 via the pressure in the working chamber 52 exceeds the locking force of the actuator 36, then it is displaced and assumes the alternatively possible setting.

In this alternatively possible setting of the actuator 36 that is not depicted in FIG. 2, the pressure side 20 of the feed pump is now connected to the recipient 12 via a channel 82 and the constrictor 58. In this setting, the previously filled recipient 10 is connected to the suction side of the feed pump via a channel 84 in the actuator 36. The previously filled recipient 10 is actively emptied via the feed pump 22 and the working fluid is supplied to the recipient 12. At the same time, the working chamber 52 is also emptied via the feed pump via the connecting means 46 and the channel 84 in the actuator 36.

A portion of the working fluid conveyed by the feed pump is supplied to the working chamber 66 via the connecting means 62 and the time-lag constrictor 64. The pressure in the second working chamber 66 now rises in accordance with the adjustment of the constrictor 64, while the recipient 12, which is the described case may be another inflatable air cushion, is pumped up. The increasing pressure in the working chamber 66 is transmitted to the pneumatic actuator 36 via a corresponding device 86 so that a force results against the spring force of the counter spring 76. If this force is sufficiently great to overcome the locking force of the actuator 36 due to the counter device 76, then a sufficiently great pressure has built up in the working chamber 66; thus, the actuator will be pushed back into its first setting (shown in FIG. 2) so that the second recipient 12, connected with the suction side of the feed pump 22, will now be actively emptied.

Thus, a complete cycle of the method in accordance with the invention to act upon at least two recipients of a pneumatic system in an alternating manner with a pressure medium flow is concluded and the system automatically begins again with the filling of the recipient 10 as described above.

Because of the alternating filling or emptying of the concerned air cushions, a system based on this invention in the seat of a motor vehicle permits seating comfort to be improved and relief for the spinal column to be achieved due to the massage effect that ensues. The frequency of this movement can be adjusted via the setting of the relative constrictor sizes 64 or 48, the extent of the volumes involved and not the least also via the required pressure medium flow. It is also easily possible for the user himself, for example, to individually adapt the frequency of the movement via direct adjustment of the strength of the counter device 76.

A small-capacity compressor, e.g., a vane-cell pump or even a diaphragm pump, can be used to circulate the working fluid of the device.

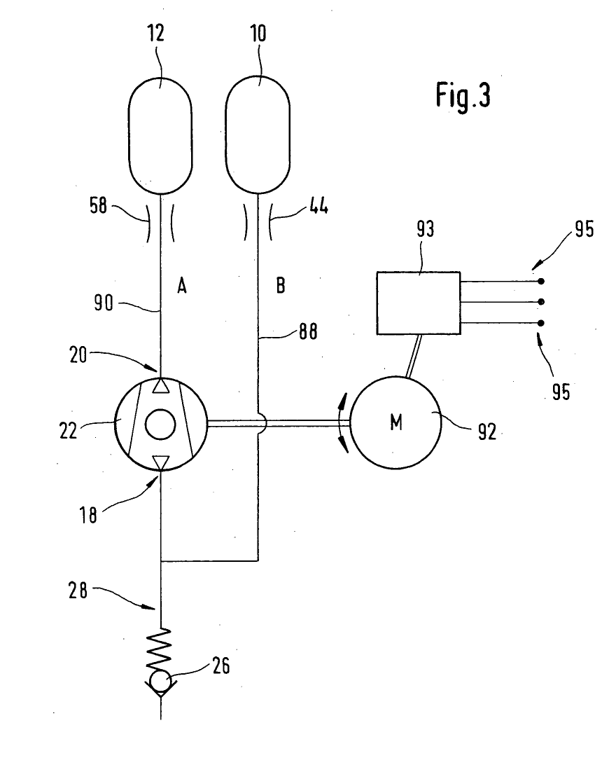

FIG. 3 shows an alternative exemplary embodiment of a pneumatic system in accordance with the invention, which makes it possible in a simple way to act upon at least two recipients of a pneumatic system in an alternating manner with a pressure medium flow. A first recipient 10 is connected to the suction side 18 of a feed pump 22 via a constrictor 44 and connecting means 88. The pressure side 20 of the pump 22 is connected in turn to a second recipient 12 via connecting means 90 and a constrictor 58. Except for an output valve 26, which is connected to the suction side 18 of the feed pump via connecting means 28, the pneumatic system in accordance with the invention therefore represents a closed cycle. It is possible in an already described manner to supply air or another working fluid to the system from the outside via the output valve 26. Thus, for example, when a specific pressure limit is reached on the suction side 18 of the feed pump 22, the valve 26, which can be embodied as a reflux valve for example, can be opened.

In the exemplary embodiment in FIG. 3, the alternating filling of the two recipients is possible in a simple manner by a reversal of the rotational direction of the feed pump 22, which can be embodied, e.g., in the form of a vane-cell pump. In this way, the pressure side and the suction side of the feed pump are exchanged in an alternating manner and the recipients are correspondingly filled or emptied. A corresponding control unit 93 can regulate the motor 92 driving the feed pump 22. Thus, for example, the final pressure to be reached in the recipients can be regulated over the run time of the feed pump and the frequency of the alternating action of the pressure medium can be varied via a corresponding reversal of the rotational direction of the electric motor. To do so, the pump control unit 93, which can be a component of a higher-order control unit, can be supplied with information from various sensors 95, e.g., sensors for the weight, body size or environmental parameters such as the temperature of the vehicle passenger compartment. Using corresponding characteristic curves stored in the control unit of the electric motor 92, a triggering of the pneumatic system that is specific to the user or the driving situation can be realized. Thus, for example, the effect can be taken into account that the pressure in the recipients can rise from a thermal expansion of the working fluid due to an increase in temperature in the vehicle passenger compartment. Various massage programs can also be stored in the control unit via corresponding characteristic curves and be called up by the vehicle user or the vehicle passengers, e.g., via a corresponding control element.

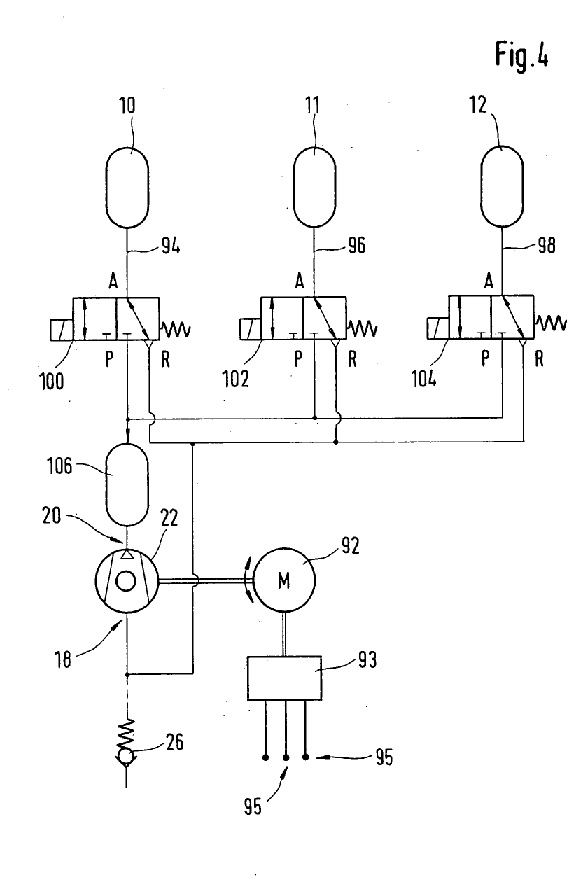

FIG. 4 shows another exemplary embodiment of a pneumatic circuit in accordance with the invention, where more than the minimum of two recipients is used. The three recipient depicted are representative of any possible number of recipients, which such a pneumatic system can included and are not supposed to represent a limitation of the universality of the pneumatic circuit in accordance with the invention.

In the exemplary embodiment in FIG. 4, three recipients 10, 11, and 12 are each connected to an actuator 100, 102 or 104 via corresponding connecting means 94, 96 and 98. The actuators, which, e.g., can be pneumatic actuators in accordance with the exemplary embodiment in FIG. 2, connect (in their settings depicted in FIG. 4) the recipients 10, 11, and 12 to the suction side 18 of a feed pump 22. In this case, the actuators in FIG. 4 are depicted in such a way that all three recipients 10, 11, and 12 are being simultaneously emptied via the feed pump 22. An alternative switching of the actuators is naturally also possible in which, e.g., a specific number of recipients are actively emptied, while another number of recipients present are simultaneously acted upon by the working fluid via the feed pump. The actuators of the pneumatic circuit in accordance with the invention, of which only three are depicted as an example in FIG. 4, can be switched to one other synchronously or asynchronously via corresponding switching programs. In this way, it is possible to realize different massage programs with a constant number of recipients in the pneumatic system. In the exemplary embodiment in FIG. 4, the recipients 10, 11, and 12 are connected to the pressure side 20 of the feed pump via the change of the actuators into their second possible position so that the working medium fluid is pumped into the recipients in the second setting of the actuators 10, 11 or 12. The pressure side of the feed pump may also feature a storage recipient 106 in this connection, which is filled with the working medium via the feed pump and can pass the working fluid on to the recipients connected to the pressure side of the feed pump via a corresponding valve element.

The method in accordance with the invention to act upon a pneumatic system in an alternating manner with a pressure medium flow or the corresponding pneumatic circuit to execute this method is not limited to the exemplary embodiments depicted in the figures. In particular, the method or the associated device is not limited to the use of air as the working medium. Even if air is preferred as an easily available and therefore cost-effective working medium, other gaseous working fluids are also possible. The use of water or other liquid working fluids involves the problem that a leak in the system can lead to a saturation of the vehicle seat so that the use of liquid working fluids shall be refrained from.

The method in accordance with the invention and the corresponding pneumatic circuit are not limited to the application in a massage system and in particular not limited to the use in the vehicle seats of a motor vehicle. On the contrary, such a pneumatic system can be used in a multiplicity of technical applications.

1. Method to act upon at least two recipients (10, 11, 12) of a pneumatic system in an alternating manner, in particular a pneumatic massage system of a motor vehicle seat, with a pressure medium flow, characterized in that at least one, first air cushion (10, 11, 12) that serves as a recipient (10, 11, 12) is filled with a gaseous working fluid, while the working fluid is actively suctioned off from at least one other, second air cushion (10, 11, 12).

2. Method according to claim 1, characterized in that the pressure in the at least one, to be-emptied recipient (10, 11, 12) is used to fill the at least one, to-be-filled air cushion (10, 11, 12).

3. Method according to claim 1, characterized in that the alternating filling of at least two air cushions (10, 11, 12) is achieved by a reversal of the rotational direction of a pump (22) conveying the working fluid.

4. Method according to claim 3, characterized in that the motor speed of a motor driving the feed pump (22), in particular an electric motor (24, 92), is presettable.

5. Method according to claim 1, characterized in that the final pressure in the at least one, to-be-filled recipient (10, 11, 12) and/or the frequency of the working fluid acting upon the at least two recipients (10, 11, 12) in an alternating manner is/are presettable.

6. Method according to claim 5, characterized in that the final pressure in the at least one, to-be-filled recipient (10, 11, 12) and/or the frequency of the working fluid acting upon the at least two recipients (10, 11, 12) in an alternating manner is/are presettable manually via corresponding operating elements in the vehicle.

7. Method according to claim 5, characterized in that the final pressure in the at least one, to-be-filled recipient (10, 11, 12) and/or the frequency of the working fluid acting upon the at least two recipients (10, 11, 12) in an alternating manner is preset by a control unit (93) in accordance with the signals of at least one sensor (95), in particular a sensor to detect occupation of the seat.

8. Method according to claim 5, characterized in that the final pressure in the at least one, to-be-filled recipient (10, 11, 12) and/or the frequency of the working fluid acting upon the at least two recipients (10, 11, 12) in an alternating manner is controlled or regulated by a constriction (34, 44, 58) of the pressure medium flow on the pressure side (20) of the feed pump (22), in particular by a throttling valve (34, 44, 58).

9. Method according to claim 5, characterized in that the final pressure in the at least one, to-be-filled air cushion (10, 11, 12) and/or the frequency of the working fluid acting upon the at least two recipients (10, 11, 12) in an alternating manner is controlled or regulated by actuating a bypass (32) between the suction side (18) and the pressure side (20) of the feed pump (22).

10. Pneumatic circuit to act upon recipients (10, 11, 12) of a pneumatic system in an alternating manner, in particular a pneumatic massage system of a motor vehicle seat, with a pressure medium flow, with at least two recipients (10, 11, 12) to alternatingly receive a pressure medium flow, with at least one pump (22) conveying the pressure medium flow as well as with driving means (24) for the feed pump (22) and with connecting means (14, 16, 18, 20, 88, 90, 94, 96, 98) between the feed pump (22) and the recipients (10, 11, 12) to be acted upon by the working fluid, characterized in that the at least one, first recipient (10, 11, 12) is connected to the at least one, second recipient (10, 11, 12) via the connecting means (14, 16, 18, 20, 88, 90, 94, 96, 98) and the feed pump (22).

11. Pneumatic circuit according to claim 10, characterized in that the at least two recipients (10, 11, 12) are connected to the at least one feed pump (22) via the connecting means (14, 16, 18, 20, 88, 90, 94, 96, 98) in such a way that the working fluid pumped out of the at least one, first recipient (10, 11, 12) can be supplied to the at least second recipient (10, 11, 12).

12. Pneumatic circuit according to claim 10, characterized in that the suction side (18) of the at least one feed pump (22) is connected to at least one, first recipient (10, 11, 12), while the pressure side (20) of the feed pump (22) is simultaneously connected to at least one, second recipient (10, 11, 12).

13. Pneumatic circuit according to claim 10, characterized in that the suction side (18) of the feed pump (22) is connected to at least one, first recipient (10, 11, 12) via a component (36, 100, 102, 104) controlling the pressure medium flow, while the pressure side (20) of the pump (22) is simultaneously connected to at least one, second recipient (10, 11, 12).

14. Pneumatic circuit according to claim 13, characterized in that the pressure side (20) of the feed pump (22) is also connected to the same component (36, 100, 102, 104) controlling the pressure medium flow.

15. Pneumatic circuit according to claim 13, characterized in that the pressure control means (36, 100, 102, 104) features a pneumatically driven actuator (36, 100, 102, 104).

16. Pneumatic circuit according to claim 15, characterized in that the pressure control means (36, 100, 102, 104) features at least one valve.

17. Pneumatic circuit according to claim 10, characterized in that the feed pump (22) is a vane-cell pump, in particular a vane-cell pump with means to reverse the rotational direction.

18. Pneumatic circuit according to claim 10, characterized in that the circuit features at least one output valve (26), which opens a connecting line (28, 14, 18, 88) when a specific pressure limit is reached on the suction side (18) of the pump (22) in order to supply additional working fluid to the system.

19. Pneumatic circuit according to claim 10, characterized in that the circuit features at least one sensor element (95), which acquires information about the occupation of the seat and transmits this information to a control unit (93) for the pneumatic circuit.

20. Vehicle seat, in particular for a motor vehicle, with at least two recipients (10, 11, 12) integrated into the seat, which recipients are to be acted upon in an alternating manner with a pressure medium flow, characterized in that at least one, first air cushion (10, 11, 12) that serves as a recipient (10, 11, 12) is filled with a gaseous working fluid, while the working fluid is actively suctioned off from at least one other, second air cushion (10, 11, 12).
